(19) United States
(12) Patent Application Publication
(10) Pub. No.: US 2007/0132307 A1
(43) Pub. Date: Jun. 14, 2007

(54) Central support unit of an axle bracket housing for motor vehicles

(76) Inventors: Han-Jürgen Fahrentholz, Espenau (DE); Walter Kupper, Spangenberg (DE)

Correspondence Address: WILLIAM COLLARD;COLLARD & ROE, P.C., 1077 NORTHERN BOULEVARD, ROSLYN, NY, 11576, US

(21) Appl. No.: 10/578,827

(22) PCT Filed: Oct. 30, 2004
(86) PCT No.: PCT/EP04/12331

§ 371 Date: Jun. 26, 2006

(30) Foreign Application Priority Data
Nov. 12, 2003 (DE) 103 52 726.5

(51) Int. Cl. B60B 35/16; B21B 23/00

(52) U.S. Cl. 301/137; 74/607; 180/378; 72/68; 29/463

(57) ABSTRACT

The invention relates to an axle bracket housing. In order to configure the latter in a cost-effective manner, the central support piece is rolled from sheet metal.

The invention relates to an axle bracket housing for motor vehicles according to the precharacterizing clause of patent claim 1. Furthermore the invention relates, according to single-part patent claim 6, to a production method for an axle bracket housing for motor vehicles.

DE 102 55 209.6-21, which is not a prior publication, describes a central support unit of an axle bracket housing for motor vehicles. This support unit is designed as a formed part.

It is the object of the invention to provide a cost-effective central support unit for an axle bracket housing for motor vehicles.

This object is achieved according to the invention by the features of patent claim 1 and the production method according to patent claim 6.

Rolled sheet metal is particularly cost-effective. In contrast to a formed bent part, which is bent from or pressed out of sheet-metal blanks without rolling, in the case of rolling little if any scrap is produced, since no sheet-metal blanks with a proportionally correspondingly high degree of scrap have to be produced.

In contrast to gray cast iron, sheet metal is easily weldable. The axle units through which the axle shaft parts lead can therefore easily be securely welded. In particular the laser welding process can be used as the welding process for the thin-walled sheets. However, any desired other welding processes are likewise also possible. Examples which may be mentioned include the electric welding process or the electron beam welding process.

In contrast to a two-part support unit which is pressed out of sheet metal, no forming presses with a complicated forming process around approx. 5000 tons are necessary. In contrast to pressing, in the case of the method according to the invention there does not have to be any cutting of the sheet-metal blank either; on the contrary, a cost-effective broad strip can be used. Similarly, a U-shaped sheet can be re-rolled to form the support unit.

The production of the support unit from a sheet which is designed as a closed, welded ring is particularly advantageous, since just a single component therefore forms the entire basic body of the support unit. A two-piece form is advantageously not necessary. Particularly advantageously, the shape of a closed ring requires only a short weld seam at the ends of the sheet rolled to form the ring. The welding of an annular support unit of this type is therefore possible rapidly and with little use of welding material. In this case, the ring does not have to be circular but rather can have a shape optimized to
the installation space, or
the weight, or
the rigidity, or
the chassis geometry, or
the shape of the differential casing, or.

In particular, partially elliptical shapes may be advantageous.

The support unit may also be composed of two sheet-metal parts which are welded to each other. If these two sheet-metal parts are identical parts, then this is cost-effective, since the two parts can be manufactured on the same rolling machine without changing the manufacturing programme. After the rolling operation, the two identical parts can be further processed differently. For example, an upper sheet-metal part can be further machined to receive an axle spring system. This axle spring system may be an air bellows support which is integrated in the axle bracket and is fastened in the vicinity of the support unit. Also when rolling the support unit from two sheet-metal parts, use can be made both of a cost-effective broad strip and of a U-shaped sheet.

Patent claim 8 shows a particularly cost-effective production method for an axle bracket housing. This concerns the preparation of the weld seam, i.e., in particular, the production of a weld groove. Since, in the case of the rolling process according to the invention, more exacting tolerances can be kept to than, for example, when pressing the support unit out of sheet metal, the weld groove does not necessarily have to be incorporated temporally after the rolling of the sheet. Since, in order to produce the weld groove, bevels are already worked onto the broad strip or the U-shaped sheet during the production of the broad strip or the U-shaped sheet, a “weld groove” operation of this type is omitted in the following working steps. In a particularly cost-effective manner, the bevels which later form the weld groove can be formed in the sheet without cutting.

In a particularly advantageous manner, it is alternatively also possible to carry out the preparation of the weld seam during the rolling process to produce the support unit. That is to say, the bevels for the weld groove are likewise rolled into the sheet during the rolling.

Further advantages of the invention emerge from the further patent claims, the description and the drawing.

The invention is explained below with reference to a drawing, in which:

FIG. 1 shows a central support unit of an axle bracket housing in a first alternative configuration,

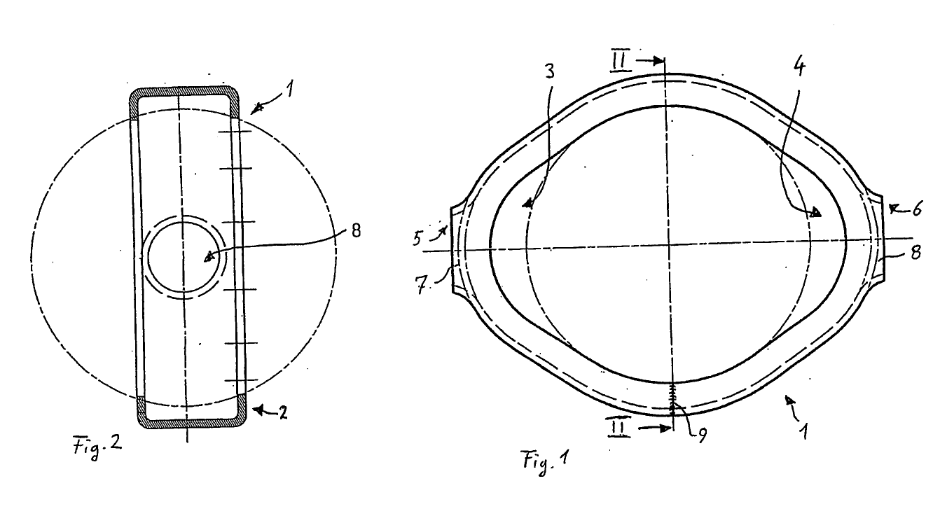

FIG. 2 shows the central support unit from FIG. 1 in a view according to line II-II from FIG. 1,

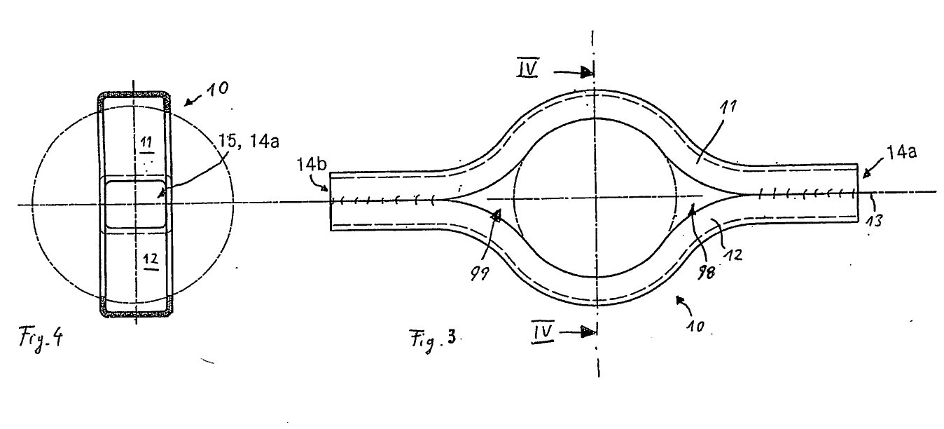

FIG. 3 shows a central support unit of an axle bracket housing in a second alternative configuration,

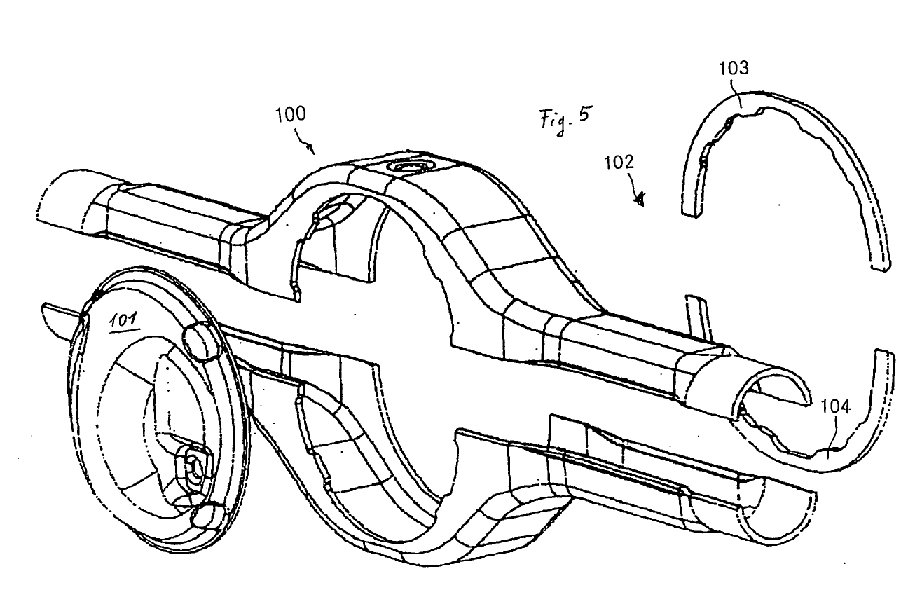

FIG. 4 shows the central support unit from FIG. 3 in a view according to line IV-IV from FIG. 3,

FIG. 5 shows, in an exploded illustration, a central support unit, a cover and a two-part reinforcing ring, and

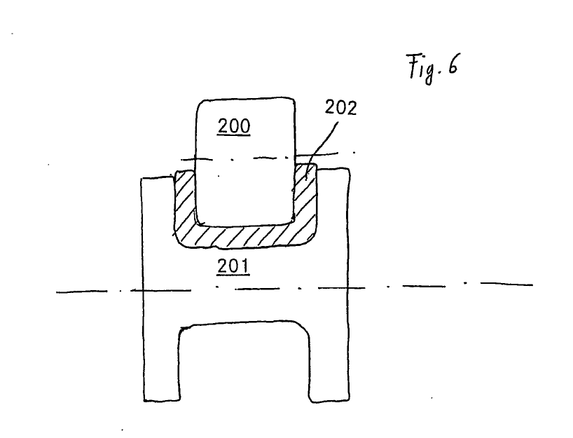

FIG. 6 shows, diagrammatically, two rollers for producing a central support unit with a U-shaped profile.

Reference is made below to DE 102 55 209.6-21, the content and terminology of which is to be considered as having been incorporated in the present application. DE 102 55 209.6-21 describes an axle bracket which is composed, inter alia, of a central support unit and two axle units fastened in a motionally fixed manner to the opposite sides thereof.

FIG. 1 shows a central support unit 1 of an axle bracket housing in a first alternative configuration.

The support unit 1 here—seen in a simplified manner—is in the form of a ring with a U-shaped profile 2. The basic shape of the ring is a hollow cylinder which has partially elliptical bulges 3, 4 on the two sides facing the axle units. These partially elliptical bulges 3, 4 each have an additional outwardly bent portion 5, 6 from which a circular cutout 7, 8 is sawed in each case, so that the two axle units which can be seen in DE 102 55 209.6-21 can be welded on there. This welding can take place, for example, with the laser welding process.

The two ends of the annular support unit 1 are arranged to form a butt joint and are likewise laser-welded by means of a weld seam 9. This weld seam 9 is situated in the central vertical plane of division of the support unit 1. In the alternative configuration illustrated in FIG. 1, the weld seam 9 is situated at the bottom in the installed position of the support unit 1. As an alternative, the weld seam could also be situated at the top in the installed position of the support unit 1.

FIG. 2 shows the central support unit 1 from FIG. 1 in a view according to line II-II from FIG. 1. The U-shaped profile 2 can clearly be seen here. The support unit 1 obtains its shape in the rolling process. That is to say, a steel strip or alternatively a steel sheet preshaped in the shape of a U is rolled along two rollers into said shape.

FIG. 3 shows a central support unit 10 of an axle bracket housing in a second alternative configuration. In contrast to the first alternative configuration, the support unit here is composed of two rolled, U-shaped sheets 11, 12. These two sheets 11, 12 have the same shape and are arranged mirror-symmetrically with respect to the central horizontal plane 13 of the support unit 10. The two sheets 11, 12 are laser-welded to each other at their two end regions. In the unwelded central part of the support unit 10, the two sheets 11, 12 gape, thus producing in the centre a cylindrical hollow shape which tapers to a point at the two sides arranged diametrically with respect to each other. A respective approximately triangular sheet-metal piece (not illustrated in the drawing) is welded into the two tapered-off portions 99, 98 forming there, after the two U-shaped sheets 11, 12 are welded together. Material scrap is therefore kept as small as possible.

The lateral openings 14a, 14b to which the two axle units are welded have a rounded rectangular shape 15, since this shape 15 arises from the two U-shaped sheets 11, 12 which are welded to each other and face each other in open form, as is apparent in FIG. 4.

FIG. 5 illustrates, with reference to a complete axle bracket housing 100, how the central support units 1, 10 according to the first two alternative configurations FIGS. 1, 2 and FIGS. 3, 4 are reinforced and closed. For this purpose, on the one hand, a cover 101 is provided and, on the other hand, a two-part reinforcing ring 102 is provided. The two-part reinforcing ring 102 comprises the two ring segments 103, 104.

In the case of both alternative configurations of the support unit 1, 10, a cylindrical hollow opening is formed centrally. This cylindrical hollow opening is closed in the direction of travel, as seen from the rear, by means of the cover 101. This cover 101 is composed of deep-drawn sheet metal and is laser-welded to the support unit 1 or 10. As seen from the front in the direction of travel, the two ring segments 103, 104 are laser-welded to the support unit slightly radially outside the outer edge of the cylindrical hollow opening. As a consequence of the welded-on ring segments 103, 104, the central region is particularly stiff, with the result that the high supporting forces which are introduced into the support unit by a differential arranged within said cylindrical hollow shape can be absorbed.

FIG. 6 shows, diagrammatically, two rollers 200, 201 for producing a central support unit 202 with a U-shaped profile. The one roller 200 is designated the positive mold and draws the broad strip, during rotation together with the second roller, which forms the negative mold, through a U-shaped gap between the two rollers 200, 201. The rollers therefore roll along both sides of the broad strip.

The broad strip may be configured both as a flat sheet-metal strip and also may be configured as a preshaped sheet-metal strip in the shape of a U.

The sheet is preferably sheet steel. The use of aluminum sheet is also possible in order to save weight and in order to be able to carry out the rolling process at lower forces. The aluminum material is weldable to axle units manufactured from aluminum.

In the case of all of the weld connections carried out in the exemplary embodiments, any technically feasible welding process is possible. This relates in particular to
the weld seam at the butt joint of the support part according to FIG. 1,
the weld seams between the two U-shaped sheets according to FIG. 3,
the weld seams on the approximately triangular sheet-metal pieces which are situated in the tapered-off portions according to FIG. 3, and
the weld seams on the two-part reinforcing ring.

In particular
the laser welding process
the metal/active gas fusion welding process, i.e. the MAG welding process
the laser/hybrid welding process which is a combination of laser beam shielded arc welding and metal shielded arc welding,
   can be used.

The rolling machine can be programmed in order to produce the shapes, which differ from the simple circular shape, according to the first and second alternative configurations of the central support unit 1 and 10, respectively.

The embodiments described are only exemplary configurations. A combination of the described features is likewise possible for different embodiments. Further features, in particular features which are not described, of the device parts belonging to the invention can be gathered from the geometries of the device parts illustrated in the drawings.

1. A central support unit of an axle bracket housing for motor vehicles, in which the support unit (1, 10) is composed of rolled sheet metal, wherein the support unit (1, 10) is welded by means of a stiffening ring (reinforcing ring 102).

2. The central support unit of an axle bracket housing for motor vehicles as claimed in patent claim 1, wherein axle units are securely welded to the central support unit (1, 10).

3. The central support unit of an axle bracket housing for motor vehicles as claimed in claim 1, wherein the support unit (1) forms a ring, the ends of which are welded to each other.

4. The central support unit of an axle bracket housing for motor vehicles as claimed in claim 1, wherein the support unit (10) is composed of two sheet-metal parts which are welded to each other.

5. The central support unit of an axle bracket housing for motor vehicles as claimed in patent claim 4, wherein the two sheet-metal parts (11, 12) are structurally identical.

6-8. (canceled)

9. The central support unit of an axle bracket housing for motor vehicles as claimed in patent claim 1, wherein the support unit (1, 10) is welded in a plane of symmetry.

10. (canceled)

11. (canceled)

12. The central support unit of an axle bracket housing for motor vehicles as claimed in patent claim 1, wherein the support unit (1, 10) has an opening which, in the installed position in the vehicle, is directed rearward and is welded by means of a cover (101).
